(19) United States
(12) Patent Application Publication
(10) Pub. No.: US 2022/0089111 A1
(43) Pub. Date: Mar. 24, 2022

(54) VEHICLE POWER CONTROL APPARATUS AND VEHICLE POWER APPARATUS

(71) Applicant: Sumitomo Wiring Systems, Ltd., Yokkaichi-shi, Mie (JP)

(72) Inventor: Kyohei Morita, Yokkaichi-shi, Mie (JP)

(21) Appl. No.: 17/423,978

(22) PCT Filed: Jan. 7, 2020
(86) PCT No.: PCT/JP2020/000097

§ 371 Date: Jul. 19, 2021

(30) Foreign Application Priority Data
Jan. 22, 2019 (JP) 2019-008416

(51) Int. Cl. B60R 16/033

(52) U.S. Cl. CPC B60R 16/033

(57) ABSTRACT

The present invention realizes technology that can drive a target load even if the remaining charge amount of a power storage unit is low, and the target load can be efficiently driven when the remaining charge amount of the power storage unit is high. A vehicle power control apparatus includes a discharge circuit that includes a discharge circuit and a switch, a voltage conversion circuit, and a control circuit that controls the discharge circuit and the voltage conversion circuit. During a failed state, if an output voltage of a power storage unit is greater than or equal to a threshold voltage, the control circuit performs control to bring the switch into the on state, and if the voltage output of the power storage unit is below the threshold voltage, the control circuit makes the voltage conversion circuit perform a voltage conversion operation.

### CROSS-REFERENCE TO RELATED APPLICATIONS

This application is the U.S. national stage of PCT/JP2020/000097 filed on January 7, 2020, which claims priority of Japanese Patent Application No. JP 2019-008416 filed on Jan. 22, 2019, the contents of which are incorporated herein.

### TECHNICAL FIELD

The present disclosure relates to a vehicle power control apparatus and a vehicle power apparatus.

### BACKGROUND

JP 2010-145143A discloses a vehicle power system provided with a power storage apparatus that includes the functionality of a backup power system. The power storage apparatus disclosed in JP 2010-145143A can operate so as to supply power from a power storage unit that is different from a main power source when power supply from the main power source has failed.

The power storage apparatus disclosed in JP 2010-145143A has a configuration where a control circuit monitors the voltage of the main power source, and the control circuit immediately turns on a changeover switch upon detecting a decrease in the voltage of the main power source. When the control circuit turns on the changeover switch, power is supplied from the power storage unit to a load.

The power storage apparatus disclosed in JP 2010-145143A employs so-called situational discharge, and in a backup operation performed in response to a power failure, a voltage that corresponds to the output voltage (terminal voltage) of the power storage unit is applied to a load. In this method, when the power storage unit continues to discharge power to the load and the remaining charge amount of the power storage unit gradually decreases, the voltage supplied to the load correspondingly decreases. Then, when the output voltage of the power storage unit falls below the minimum driving voltage of the load, the load cannot be driven. That is, in the power storage apparatus disclosed in JP 2010-145143A, in the case where the output voltage of the power storage unit falls below the minimum driving voltage of the load, all of the charge can no longer be used, and thus the unused charge is wasted.

On the other hand, consideration has also been given to replacing the power storage apparatus disclosed in JP 2010-145143A with a backup apparatus 102 such as that shown in FIG. 3. The backup apparatus 102 shown in FIG. 3 uses a voltage conversion circuit 130 as a discharge circuit, and if a control circuit 110 detects that the output voltage of a power unit 191 is less than or equal to a threshold voltage, the control circuit 110 makes the voltage conversion circuit 130 perform a voltage conversion operation such that a constant voltage is output from the voltage conversion circuit 130. Specifically, the control circuit 110 controls the voltage conversion circuit 130 such that the voltage conversion circuit 130 is made to perform a step-down operation if the output voltage (terminal voltage) of a power storage unit 192 exceeds the above-described constant voltage (target voltage), and makes the voltage conversion circuit 130 perform a step-up operation if the output voltage (terminal voltage) of the power storage unit 192 falls below the above-described constant voltage (target voltage). By using this method, even if the output voltage (terminal voltage) of the power storage unit 192 falls below the minimum driving voltage of a load 194, a voltage that is greater than or equal to the minimum driving voltage can be supplied to the load 194 due to the step-up operation, and thus the problem of the power storage apparatus disclosed in JP 2010-145143A can be easily solved. However, there is the concern that a drop in efficiency will occur due to voltage conversion when a measure such as this backup apparatus 102 is employed alone.

Thus, it is an object of the present invention to provide vehicle technology that can drive a target load even when the remaining charge amount of the power storage unit is low, and efficiently drive the target load when the remaining charge amount of the power storage apparatus is high.

### SUMMARY

A vehicle power control apparatus according to one aspect of the present disclosure is a vehicle power control apparatus that controls a vehicle power system including a power unit that supplies power to a load, and a power storage unit that supplies power to the load via a load-side conductive path at least if power supply from the power unit enters a failed state. The vehicle power control apparatus includes a discharge circuit that includes a discharge path provided between the power storage unit and the load-side conductive path, and a switch provided on the discharge path, and is configured such that the load-side conductive path and the power storage unit are electrically connected via the discharge path when the switch enters an on state. The vehicle power control apparatus further includes a voltage conversion circuit that is provided between the power storage unit and the load-side conductive path, and is configured to perform at least a voltage conversion operation of converting a voltage of a power storage unit-side conductive path electrically connected to the power storage unit and applying a target voltage to the load-side conductive path; and a control circuit configured to control the discharge circuit and the voltage conversion circuit. Wherein, during the failed state, if an output voltage of the power storage unit is greater than or equal to a threshold voltage, the control circuit performs control to bring the switch into the on state, and if the output voltage of the power storage unit is below the threshold voltage, the control circuit makes the voltage conversion circuit perform the voltage conversion operation.

A vehicle power apparatus according to one aspect of the present disclosure includes the vehicle power control apparatus; and the power storage unit.

### Advantageous Effects of Invention

According to the present disclosure, a target load can be driven even when the remaining charge amount of the power storage unit is low, and the target load can be efficiently driven when the remaining charge amount of the power storage unit is high.

### BRIEF DESCRIPTION OF DRAWINGS

FIG. 1 is a block diagram schematically showing an example of a vehicle power system including a vehicle power control apparatus according to Embodiment 1.

FIG. 2 is a flowchart showing an example of a flow of control regarding a backup operation executed by the vehicle power control apparatus according to Embodiment 1.

FIG. 3 is a block diagram schematically showing an example of a vehicle power system including a vehicle power control apparatus according to a comparative example.

FIG. 4 is a graph showing a relation between a load current and a load voltage when power required by a load is P.

FIG. 5 is a graph showing a relation between an output voltage and a load current according to a method disclosed in prior technology.

FIG. 6 is a graph showing a relation between an output voltage and a load current according to a method disclosed in the comparative example.

FIG. 7 is a graph showing a relation between an output voltage, a load current, and a voltage of a power storage unit according to a method disclosed in the embodiment.

### DETAILED DESCRIPTION OF PREFERRED EMBODIMENTS

First, embodiments of the present disclosure will be listed and described.

A vehicle power control apparatus that desirably includes a discharge circuit that includes a discharge path provided between a power storage unit and a load-side conductive path, and a switch provided on the discharge path, and is configured such that the load-side conductive path and the power storage unit are electrically connected via the discharge path when the switch enters an on state; a voltage conversion circuit that is provided between the power storage unit and the load-side conductive path, and is configured to perform at least a voltage conversion operation of converting a voltage of a power storage unit-side conductive path electrically connected to the power storage unit and applying a target voltage to the load-side conductive path; and a control circuit configured to control the discharge circuit and the voltage conversion circuit. The control circuit is desirably configured to, during a failed state, if an output voltage of the power storage unit is greater than or equal to a threshold voltage, perform control to bring the switch into the on state, and if the output voltage of the power storage unit is below the threshold voltage, make the voltage conversion circuit perform the voltage conversion operation.

In this way, because the voltage conversion circuit can be made to perform a voltage conversion operation and output a target voltage if the output voltage of the power storage unit is less than a threshold voltage, it is easier to drive the target load even in cases such as when the output voltage of the power storage unit is lower than the target voltage (a case where the remaining charge amount of the power storage unit is low). On the other hand, if the output voltage of the power storage unit is greater than or equal to the threshold voltage (a case where the remaining charge amount of the power storage unit is high), an output current can be kept from being forcefully increased and can be output as an output current that corresponds to power required by the load and the output voltage of the power storage unit, and thus a consumption current can be suppressed and the target load can be efficiently driven.

The control circuit may, after the failed state has occurred, keep the switch in the on state and stop the voltage conversion operation performed by the voltage conversion circuit while the output voltage of the power storage unit is greater than or equal to the threshold voltage, and after the failed state has occurred, if the output voltage of the power storage unit falls below the threshold voltage while the switch is kept in the on state, the control circuit may make the voltage conversion circuit perform the voltage conversion operation.

In this way, in the period in which the backup operation is carried out, only the discharge circuit, and not the voltage conversion circuit, is used in a relatively early period, and the necessary power can be supplied to the load while further suppressing power consumption. Also, as a result of using the voltage conversion circuit to perform a voltage conversion operation in a relatively late period, the backup operation can be continued until the output voltage of the power storage unit is even lower.

After the failed state has occurred, in a period in which the switch is kept in the on state until the output voltage of the power storage unit reaches the threshold voltage and a period for which the voltage conversion operation is performed after the output voltage of the power storage unit has reached the threshold voltage, a voltage capable of driving the load may continue to be applied to the load-side conductive path. In this way, a voltage capable of driving the load can be output during a discharge operation performed by the discharge circuit and during a discharge operation performed by the voltage conversion circuit, and it is possible to eliminate a period in which a voltage capable of driving the load cannot be output before and after changeover of the switch.

The threshold voltage may be lower than the target voltage. In this way, discharge by the discharge circuit can be continued for longer, and thus the effect of suppressing a consumption current can be further expressed.

The target load may be a vehicle brake system. In this way, even after a failed state occurs, power can continue to be supplied to the vehicle brake system for which power supply is desired during a power failure, and furthermore, a configuration that can perform such a backup operation can be realized with a configuration that is smaller and can continue to perform a backup operation for a longer period of time.

The power storage unit may be an electric double layer capacitor.

A property of an electric double layer capacitor is that the supply voltage decreases as the remaining charge amount decreases, and thus if the power storage unit is configured as an electric double layer capacitor, an effect related to the above-described property can be further exhibited.

A specific example of the attachment structure of mounted components of the present disclosure will be described below with reference to the drawings. Note that the present invention is not limited to these examples, but is indicated by the claims, and all changes that come within the meaning and range of equivalency of the claims are intended to be embraced therein.

### Embodiment 1

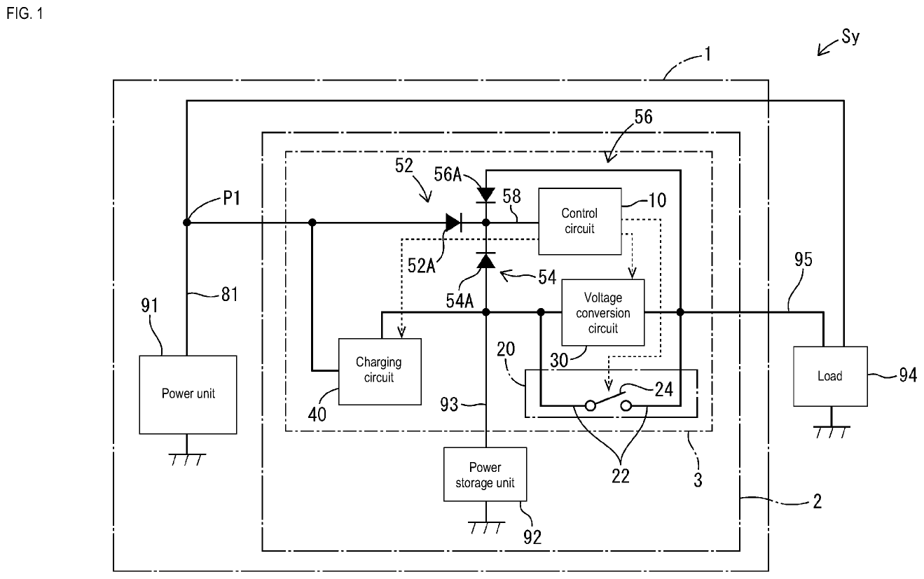

FIG. 1 shows a vehicle system Sy provided with a vehicle power system 1 (hereinafter also referred to as “power system 1”) and a load 94 that receives power supplied from the vehicle power system 1. The vehicle power system 1 shown in FIG. 1 includes a power unit 91 that functions as the main power source, a power storage unit 92 that functions as a backup power source, and a vehicle power control apparatus 3 (hereinafter also referred to as “control apparatus 3”). The power system 1 is configured as a system that can supply power to the load 94 by using the power system 1, and is configured as a system in which the control apparatus 3 can control a backup operation when a failed state occurs. Note that, while the load 94 is illustrated as a power supply target in FIG. 1, the load 94 corresponds to various electrical components such as a shift-by-wire control system and an electronic control brake system, and there are no limitations on the type and number of loads.

The power unit 91 is a power unit installed in a vehicle and functions as a main power source for supplying power to various targets. The power unit 91 is configured as a known in-vehicle battery such as a lead battery. A high potential-side terminal of the power unit 91 is electrically connected to wiring 81 and applies a predetermined output voltage to the wiring 81. Note that fuses, an ignition switch, and the like are omitted from FIG. 1.

The power storage unit 92 is constituted by known power storage means such as an electric double layer capacitor (EDLC), for example. The power storage unit 92 is electrically connected to a charging circuit 40, a voltage conversion circuit 30, and a discharge circuit 20 via a power storage unit-side conductive path 93, is charged by the charging circuit 40, and is discharged by the voltage conversion circuit 30 and the discharge circuit 20. The power storage unit 92 applies an output voltage that corresponds to the charge thereof to the power storage unit-side conductive path 93. The power storage unit 92 functions as a backup power source, and becomes a power supply source when at least the power unit 91 ceases to supply power. In this configuration, a vehicle power apparatus 2 (hereinafter also referred to as “power apparatus 2”) is configured by the power storage unit 92 and the later-described control apparatus 3.

While the power system 1 is in a normal state in which there is no decrease in the power supplied from the power unit 91, an output voltage of the power unit 91 is applied to the wiring 81 acting as a power line, and power is supplied from the power unit 91 to various electrical components via the wiring 81. In this configuration, “during a normal state in which power supply from the power unit 91 is not in a failed state” refers to when the output voltage of the power unit 91 exceeds a predetermined value, specifically, when the voltage of the wiring 81 detected by a control circuit 10 (more specifically, a voltage detected at a predetermined position P1 of the wiring 81) exceeds a predetermined voltage. Conversely, “during a state where power supply from the power unit 91 is in a failed state” refers to when the output voltage of the power unit 91 is less than or equal to a predetermined voltage, specifically, when the voltage of the wiring 81 detected by the control circuit 10 (more specifically, a voltage detected at the predetermined position P1 of the wiring 81) is less than or equal to a predetermined voltage. Note that the output voltage of the power unit 91 refers to an inter-terminal voltage between a high potential-side terminal and a low potential-side terminal of the power unit 91.

The control apparatus 3 is provided with the charging circuit 40, the voltage conversion circuit 30, the control circuit 10, and the like.

The charging circuit 40 is a circuit for performing a charging operation of charging the power storage unit 92 based on power supplied from the power unit 91, and is configured as a known charging circuit such as a DC/DC converter, and is configured so as to be controlled by the control circuit 10. The control circuit 10 performs charging control such that a charge instruction signal instructing that the power storage unit 92 be charged or a charge stop signal instructing that charging of the power storage unit 92 be stopped are given to the charging circuit 40. The control circuit 10 makes the charging circuit 40 start a charging operation at, for example, a predetermined charging start timing (for example, when the ignition switch enters an on state), and gives a charge instruction signal to the charging circuit 40 until the output voltage (charging voltage) of the power storage unit 92 reaches a set target charging voltage. Note that the value of the target charging voltage is higher than a later described threshold voltage Vth. Upon receiving a charge instruction signal from the control circuit 10, the charging circuit 40 performs a voltage conversion operation of stepping up or stepping down a power source voltage input thereto via the wiring 81, and applies the converted voltage to the power storage unit-side conductive path 93 connected to the power storage unit 92. When the charging circuit 40 receives a charge stop signal from the control circuit 10, the charging circuit 40 does not perform a charging operation and cuts off the electrical connection between the wiring 81 and the power storage unit 92.

The voltage conversion circuit 30 is provided between the power storage unit 92 and a load-side conductive path 95, and can perform at least a voltage conversion operation of applying a target voltage to the load-side conductive path 95 by stepping up or stepping down the voltage of the power storage unit-side conductive path 93 electrically connected to the power storage unit 92. The voltage conversion circuit 30 is configured as a known synchronous rectification-type or diode-type step-up/down DC/DC converter, and is configured so as to be controlled by the control circuit 10. The control circuit 10 gives the voltage conversion circuit 30 a discharge instruction signal instructing that the power storage unit 92 be discharged or a discharge stop signal instructing that the power storage unit 92 stop discharging. In response to a signal from the control circuit 10, the voltage conversion circuit 30 performs a discharge operation of discharging a discharge current from the power storage unit 92 to the load 94, and a cut-off operation of cutting off the discharge current. In the case where a discharge instruction signal is received from the control circuit 10, the voltage conversion circuit 30 performs a step-up operation or a step-down operation on an input voltage that is the voltage of the power storage unit-side conductive path 93 to which the output voltage of the power storage unit 92 is applied, and performs a discharge operation so as to apply a set target voltage to the load-side conductive path 95 on the output side (specifically, a discharge operation of applying a target voltage set by the control circuit 10 to the load-side conductive path 95). In the case where the voltage conversion circuit 30 receives a discharge stop signal from the control circuit 10, a cut-off operation is performed in which such a discharge operation is stopped, and the electrical connection between the load-side conductive path 95 and the power storage unit 92 is cut off. Because the load-side conductive path 95 electrically connected to the load 94 is connected to the output side of the voltage conversion circuit 30, the output current (discharge current) output from the voltage conversion circuit 30 can be supplied to the load 94 when the voltage conversion circuit 30 performs the discharge operation. Note that here, the voltage conversion circuit 30 is described as being a step-up/down DC/DC converter, but the voltage conversion circuit 30 may be a DC/DC converter equipped with only a step-up function.

The discharge circuit 20 includes a discharge path 22 provided between the power storage unit 92 and the load-side conductive path 95 and a switch 24 provided on the discharge path 22. The discharge circuit 20 is a circuit according to which the load-side conductive path 95 and the power storage unit 92 become electrically connected via the discharge path 22 when the switch 24 is turned on. The switch 24 may be, for example, a known semi-conductor switch element such as an FET or a bi-polar transistor, and may also be a known mechanical relay.

A power circuit 52 of the control circuit 10 includes a conductive path that electrically connects a diode 52A, an anode of the diode 52A, and the wiring 81, and a conductive path that electrically connects the cathode of the diode 52A and a power line 58 of the control circuit 10. A power circuit 54 of the control circuit 10 includes a conductive path that electrically connects a diode 54A, an anode of the diode 54A, and the power storage unit-side conductive path 93, and a conductive path that electrically connects the cathode of the diode 54A and the power line 58. A power circuit 56 of the control circuit 10 includes a conductive path that electrically connects a diode 56A, the anode of the diode 56A, and the load-side conductive path 95, and a conductive path that electrically connects the cathode of the diode 56A and the power line 58. Note that the power circuit 54 is configured so as to output a lower voltage than the power circuit 52 when power supply from the power unit 91 is normal, and keeps a current from flowing from the power storage unit 92 side to the power line 58 side via the diode 54A during a normal state. Power can be supplied to the control circuit 10 via the power circuit 54 from when power supply from the power unit 91 fails to when the discharge circuit 20 outputs a voltage. If, after the discharge circuit 20 has output a voltage after the failed state has occurred, the voltage output by the power circuit 54 falls below the voltage output by the power circuit 56, power can be supplied to the control circuit 10 via the power circuit 56.

The control circuit 10 is a circuit that controls the charging circuit 40, the voltage conversion circuit 30, the discharge circuit 20, and the like. The control circuit 10 is constituted by, for example, a micro-computer, and includes a CPU, a memory such as a ROM or a RAM, an AD converter, and the like. Even when power supply from the power unit 91 is interrupted, the control circuit 10 can receive power from the power storage unit 92 so as to be able to operate.

Next, control regarding a backup operation will be described.

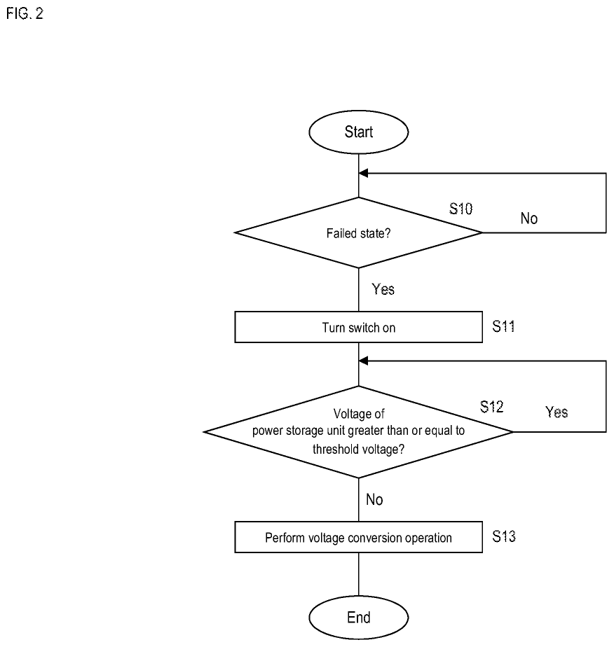

The control circuit 10 starts backup operation control shown in FIG. 2 under the condition that, for example, the vehicle has switched from a stopped state to a start state (for example, when a predetermined start switch (an ignition switch or another start switch) provided in the vehicle is switched from an off state to an on state).

Once the control shown in FIG. 2 has been started, the control circuit 10 continuously monitors whether or not the power supply from the power unit 91 has entered a failed state (step S10). The control circuit 10 monitors the voltage at the predetermined position P1 via a voltage signal line (not shown). In step S10, the control circuit 10 determines whether or not the voltage at the predetermined position P1 (voltage of high potential-side terminal of power unit 91) has fallen below a reference voltage value V1, and, if the value of the voltage at the predetermined position P1 has not fallen below the reference voltage value V1, determines No in step S10 and performs the determination in step S10 again. That is, after the control in FIG. 2 is started, as long as the value of the voltage taken at the predetermined position P1 does not fall below the reference voltage value V1, the control circuit 10 repeats the determination of step S10 and repeatedly determines No in step S10.

If it is determined in step S10 that the value of the voltage at the predetermined position P1 has fallen below the reference voltage value V1, that is, if it is determined that the power supply from the power unit 91 has entered a failed state (if Yes is determined in step S10), the control unit 10 switches the switch 24 of the discharge circuit 20 from an off state to an on state in step S11. After performing the processing in step S11, the control circuit 10 performs the processing in step S12 to determine whether or not the voltage of the power storage unit 92 is greater than or equal to a threshold voltage Vth. The control circuit 10 monitors the value of the output voltage of the power storage unit 92 (specifically, the voltage value of the high potential-side terminal) via a voltage signal line (not shown), and determines whether or not the value of the output voltage of the power storage unit 92 is greater than or equal to the threshold voltage Vth. Note that the output voltage of the power storage unit 92 means the inter-terminal voltage between the high potential-side terminal and the low potential-side terminal of the power storage unit 92.

In step S12, the control circuit 10 determines Yes in step S12 if the value of the output voltage of the power storage unit 92 is greater than or equal to the threshold voltage Vth, and performs the processing in step S11 again. That is, after Yes has been determined in step S10, the control circuit 10 continues the processing of step S11 and repeatedly determines Yes in step S12 for as long as the value of the output voltage of the power storage unit 92 does not fall below the threshold voltage Vth. The threshold voltage Vth is, for example, a value lower than the above-described predetermined voltage value (reference voltage value V1), and is a value lower than the output voltage of the power storage unit 92 when fully charged (the value of the output voltage applied to the power storage unit-side conductive path 93 when the power storage unit 92 is fully charged). Also, the value of the output voltage of the fully charged power storage unit 92 (inter-terminal voltage) may be larger or smaller than the above-described predetermined voltage value (reference voltage value V1). Also, the value of the output voltage of the fully charged power storage unit 92 may be larger or smaller than the value of the output voltage of the fully charged power unit 91 (inter-terminal voltage).

Note that, in this configuration, for example, under the condition that the vehicle has switched from a stopped state to a start state (for example, when a predetermined start switch (an ignition switch or another start switch) provided in the vehicle is switched from an off state to an on state), the control circuit 10 causes the charging circuit 40 to perform a charging operation to charge the power storage unit 92 such that the voltage output from the power storage unit 92 (charging voltage) reaches a value that is greater than or equal to the predetermined reference value, which is larger than the threshold voltage Vth, (specifically, such that the value of the voltage applied to the power storage unit-side conductive path 93 becomes greater than or equal to the predetermined reference value). Accordingly, once such charging is complete, the value of the output voltage (charging voltage) of the power storage unit 92, that is, the value of the voltage applied to the power storage unit-side conductive path 93 is kept at a value larger than the threshold voltage Vth.

Also, in this configuration, the control circuit 10 keeps the switch 24 off for the period of time from when the control shown in FIG. 2 is started to when the processing in step S11 is started. Also, in the period of time from when the control shown in FIG. 2 is started to when the processing in step S13 is started, the voltage conversion circuit 30 is kept in the stopped state. Accordingly, the control circuit 10 keeps the voltage conversion circuit 30 in the stopped state while the processing in step S11 is continued. In this way, after the above-described failed state has occurred, while the output voltage of the power storage unit 92 is greater than or equal to the threshold voltage Vth (during the period of time from when Yes is determined in step S10 to when No is determined in step S12), the control circuit 10 keeps the switch 24 in an on state and stops the voltage conversion operation performed by the voltage conversion circuit 30.

If the value of the output voltage of the power storage unit 92 is not determined as being greater than or equal to the threshold voltage Vth in step S12 (if No is determined in step S12), the control circuit 10 performs a voltage conversion operation in step S13. Specifically, the control circuit 10 starts driving of the voltage conversion circuit 30 and causes it to perform a voltage conversion operation so as to convert the voltage applied to the power storage unit-side conductive path 93 and apply a target voltage to the load-side conductive path 95. The value of the target voltage output by the voltage conversion circuit 30 is larger than the value of the minimum driving voltage for driving the load 94, and may be a constant value that is larger or smaller than the threshold voltage Vth. The minimum driving voltage is the lowest value with which the load 94 can be driven within a range of voltages applied to the load 94. This processing in step S13 can be continued for as long as enough charge is stored for the above-described voltage conversion operation to be performed.

Here, effects of this disclosure will be described.

The control apparatus 3 according to the present disclosure includes the discharge circuit 20 that includes a discharge path 22 provided between the power storage unit 92 and the load-side conductive path 95 and the switch 24 provided on the discharge path 22, and enters a conductive state via the discharge path 22 between the load-side conductive path 95 and the power storage unit 92 when the switch 24 is in an on state. Furthermore, the control apparatus 3 includes the voltage conversion circuit 30 that is provided between the power storage unit 92 and the load-side conductive path 95 and can at least perform a voltage conversion operation of converting the voltage of the power storage unit-side conductive path 93 electrically connected to the power storage unit 92 and applying a target voltage to the load-side conductive path 95. The control apparatus 3 also includes the control circuit 10 that controls the discharge circuit 20 and the voltage conversion circuit 30. Thus, if the output voltage of the power storage unit 92 is greater than or equal to the threshold voltage Vth during a failed state, the control circuit 10 performs control to turn the switch 24 on, and if the output voltage of the power storage unit 92 is less than the threshold voltage Vth, the control circuit 10 makes the voltage conversion circuit 30 perform a voltage conversion operation.

In this way, because the voltage conversion circuit 30 can be made to perform a voltage conversion operation and output a target voltage if the output voltage of the power storage unit 92 is less than a threshold voltage, it is easy to drive the target load 94 even in cases such as when the output voltage of the power storage unit 92 is lower than the target voltage (a case where the remaining charge amount of the power storage unit 92 is low). On the other hand, if the output voltage of the power storage unit 92 is greater than or equal to the threshold voltage Vth (a case where the remaining charge amount of the power storage unit 92 is high), an output current can be kept from being forcefully increased and can be an output current that corresponds to power required by the load 94 and the output voltage of the power storage unit 92, and thus a consumption current can be suppressed and the target load 94 can be efficiently driven.

Here, effects of this configuration are described in more detail.

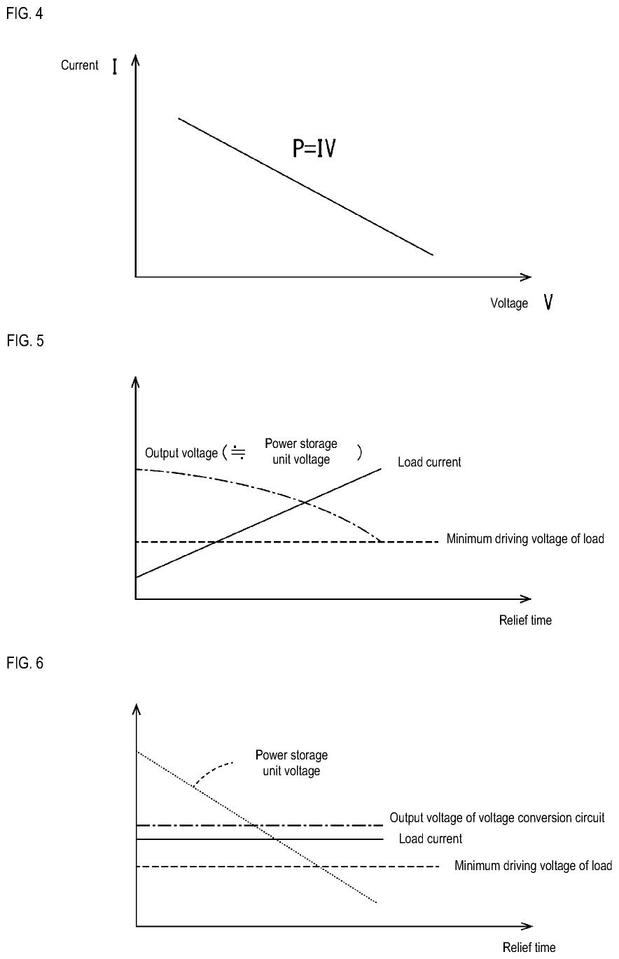

For example, if the power required by the load 94 is P, the relation between the current and voltage required for generating the power P is as shown in FIG. 4. That is, only a small current is required when the applied voltage is large, and the smaller the applied voltage is, the larger the current is. With this in mind, considering the situational discharge carried out in JP 2010-145143A, this method has the characteristic of being able to perform a backup operation using a high output voltage from the power storage unit for a certain period of time immediately after when a backup operation is started as shown in FIG. 5, and thus the consumption current can be easily suppressed. However, with this method, a backup operation cannot be performed if the output voltage of the power storage unit falls below the minimum driving voltage of the load, and thus the charge accumulated in the power storage unit will be wasted thereafter.

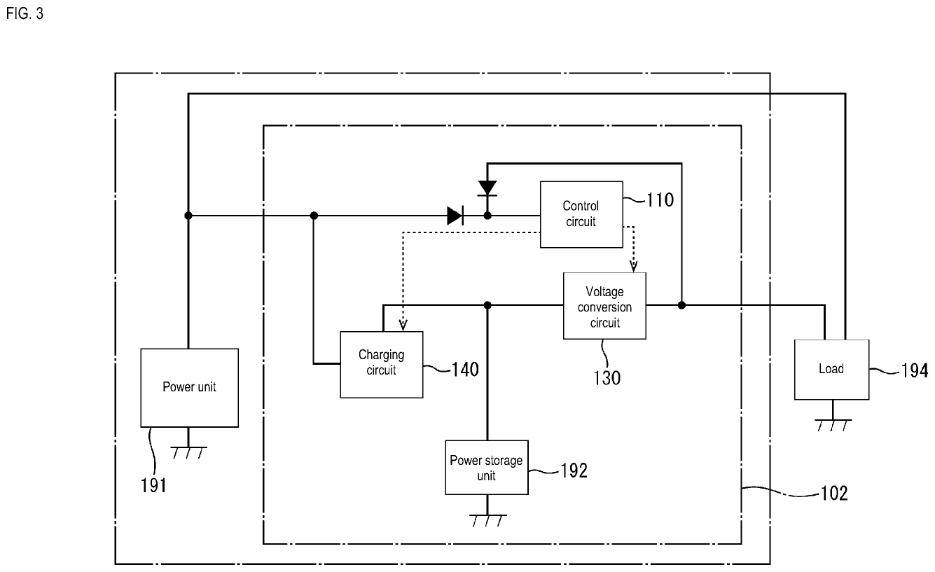

On the other hand, with an apparatus such as that shown in FIG. 3, a change occurs such as that shown in FIG. 6. This apparatus can output the target voltage (output voltage) by using the voltage conversion circuit 130 immediately after the backup operation has been started, and the target voltage (output voltage) can continue to be output even if the output voltage of the power storage unit 192 falls below the minimum driving voltage of the load, and thus there is the benefit of being able to continue a backup operation. However, in this method, even when the output voltage of the power storage unit is high, the voltage is suppressed to and output at the target voltage, and thus the consumption current correspondingly increases. In particular, it cannot be denied that there is a reduction in efficiency during the period in which the output voltage of the power storage unit 192 is greater than the target voltage (output voltage).

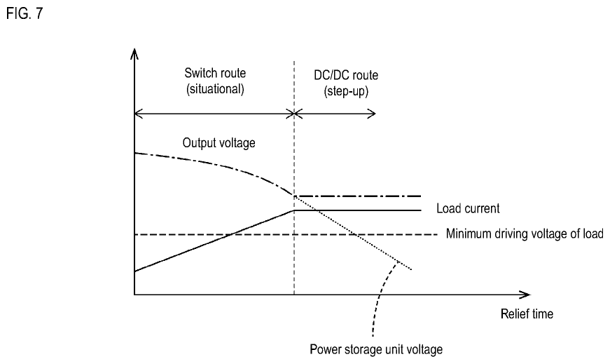

However, in the above-described present configuration, as shown in FIG. 7, the backup operation using the discharge circuit 20 can be performed in the period when the output voltage of the power storage unit 92 is high, and therefore the consumption current (load current) during this period can be remarkably suppressed, and this effect can be tied to an increase in the length of the backup period or a reduction in the size of the power storage unit 92. Furthermore, in the case where the output voltage of the power storage unit 92 is low, a backup operation can be continued so that the voltage conversion circuit 30 can step-up the voltage, and thus the backup operation can be continued for a longer period of time.

After a failed state has occurred, while the output voltage of the power storage unit 92 is greater than or equal to the threshold voltage Vth, the control circuit 10 keeps the switch 24 on and stops the voltage conversion operation of the voltage conversion circuit 30, and if the output voltage from the power storage unit 92 falls below the threshold voltage Vth while the switch 24 is on after the failed state has occurred, the control circuit 10 operates to make the voltage conversion circuit 30 perform a voltage conversion operation. In this way, in the period in which the backup operation is carried out, only the discharge circuit 20, and not the voltage conversion circuit 30, is used in a relatively early period, and the necessary power can be supplied to the load 94 while further suppressing power consumption. Also, as a result of using the voltage conversion circuit 30 to perform a voltage conversion operation in a relatively late period, the backup operation can be continued until the output voltage of the power storage unit 92 is even lower.

After a failed state has occurred, in the period in which the switch 24 is kept on until the output voltage of the power storage unit 92 reaches the threshold voltage Vth and the period in which the voltage conversion operation is performed after the output voltage of the power storage unit 92 has become the threshold voltage Vth, the control apparatus 3 continues to apply a voltage capable of driving the load 94 to the load-side conductive path 95. In this way, a voltage capable of driving the load can be output during a discharge operation performed by the discharge circuit 20 and during a discharge operation performed by the voltage conversion circuit 30, and it is possible to eliminate a period in which a voltage capable of driving of the load 94 cannot be output before and after changeover of the switch.

In the control apparatus 3, the threshold voltage Vth is smaller than the target voltage output by the voltage conversion circuit 30. In this way, the discharge circuit 20 can continue to discharge for longer.

The load 94 that is the target of the control performed by the control apparatus 3 may be a vehicle brake system. With this configuration, even after a failed state occurs, power can continue to be supplied to the vehicle brake system for which power supply is desired during a power failure, and furthermore, a configuration that can perform such a backup operation can be realized with a configuration that is smaller and can continue to perform a backup operation for a longer period of time.

The power storage unit 92 may be an electric double layer capacitor. A property of an electric double layer capacitor is that the supply voltage decreases as the remaining charge amount decreases, and thus if the power storage unit 92 is configured as an electric double layer capacitor, an effect related to the above-described property can be further exhibited.

### Other Embodiments of the Present Disclosure

The embodiments disclosed here are to be considered in all respects as illustrative and not limiting. For example, the following embodiments can be employed.

In the above-described embodiment, in the case where the control shown in FIG. 2 is performed, the voltage conversion circuit 30 was described as being stopped from when the control shown in FIG. 2 is started until the processing in step S11 is started (specifically, until the processing in step S13 is started), but the present invention is not limited to this. For example, the control circuit 10 may make the voltage conversion circuit 30 start a voltage conversion operation upon the control shown in FIG. 2 being started, and make the voltage conversion circuit 30 operate so as to continuously output a voltage lower than that of the power unit 91 to the load-side conductive path 95. In this case, it is sufficient to stop the voltage conversion circuit 30 after the processing in step S11 is started.

In the above-described embodiment, a lead battery is used as the power unit 91, which is the main power unit, but the power unit 91 is not limited to this configuration, and in either the above-described embodiment or a modification of the above-described embodiment, a known power storage battery other than a lead battery may be used. The power unit 91 is not limited to being configured by one power means, and may be configured by a plurality of power means

In the above-described embodiment, an electronic double layer capacitor (EDLC) was used as the power storage unit 92, but the power storage unit 92 is not limited to this configuration, and in either the above-described embodiment or a modification of the above-described embodiment, another power storage means such as a lithium ion battery, a lithium ion capacitor, a nickel-metal hydride battery, or the like may be used as the power storage unit 92. Also, the power storage unit 92 is not limited to being configured by one power storage means, and may be configured by a plurality of power storage means

In the above-described embodiment, the charging circuit 40 configured by a DC/DC converter was described as an example, but in either the above-described embodiment or a modification of the above-described embodiment, there is no limitation to this example, and various known charging circuits can be used.

In the above-described embodiment, an example was described in which the discharge circuit has one switch, but it may have two or more.

In the above-described embodiment, the discharge circuit 20 is provided separate from the voltage conversion circuit 30, but the voltage conversion circuit 30 may also function as a discharge circuit. In this case, the voltage conversion circuit 30 can realize a function of performing the above-described voltage conversion operation and a function of electrically connecting the power storage unit-side conductive path 93 and the load-side conductive path 95 (for example, a function of applying a voltage of the same magnitude as the voltage of the power storage unit-side conductive path 93 to the load-side conductive path 95).

1. A vehicle power control apparatus that controls a vehicle power system including a power unit that supplies power to a load, and a power storage unit that supplies power to the load via a load-side conductive path at least if power supply from the power unit enters a failed state, the vehicle power control apparatus comprising:
a discharge circuit that includes a discharge path provided between the power storage unit and the load-side conductive path, and a switch provided on the discharge path, and is configured such that the load-side conductive path and the power storage unit are electrically connected via the discharge path when the switch enters an on state;
a voltage conversion circuit that is provided between the power storage unit and the load-side conductive path, and is configured to perform at least a voltage conversion operation of converting a voltage of a power storage unit-side conductive path electrically connected to the power storage unit and applying a target voltage to the load-side conductive path; and
a control circuit configured to control the discharge circuit and the voltage conversion circuit,
wherein, during the failed state, if an output voltage of the power storage unit is greater than or equal to a threshold voltage, the control circuit performs control to bring the switch into the on state, and if the output voltage of the power storage unit is below the threshold voltage, the control circuit makes the voltage conversion circuit perform the voltage conversion operation.

2. The vehicle power control apparatus according to claim 1, wherein, after the failed state has occurred, the control circuit keeps the switch in the on state and stops the voltage conversion operation performed by the voltage conversion circuit while the output voltage of the power storage unit is greater than or equal to the threshold voltage, and
after the failed state has occurred, if the output voltage of the power storage unit falls below the threshold voltage while the switch is kept in the on state, the control circuit makes the voltage conversion circuit perform the voltage conversion operation.

3. The vehicle power control apparatus according to claim 1, wherein, after the failed state has occurred, in a period in which the switch is kept in the on state until the output voltage of the power storage unit reaches the threshold voltage and a period for which the voltage conversion operation is performed after the output voltage of the power storage unit has reached the threshold voltage, a voltage capable of driving the load continues to be applied to the load-side conductive path.

4. The vehicle power control apparatus according to claim 1, wherein the threshold voltage is smaller than the target voltage.

5. The vehicle power control apparatus according to claim 1, wherein the load is a vehicle brake system.

6. The vehicle power control apparatus according to claim 1, wherein the power storage unit is an electric double layer capacitor.

7. A vehicle power apparatus comprising:
the vehicle power control apparatus according to claim 1; and
the power storage unit.
